(19) United States
(12) Patent Application Publication
(10) Pub. No.: US 2020/0256979 A1
(43) Pub. Date: Aug. 13, 2020

(54) INTERFEROMETRIC RADAR IMPLEMENTED USING MULTIPLE ANTENNAS TRANSMITTING FREQUENCY MODULATED CONTINUOUS WAVE SIGNALS

(71) Applicant: OEWAVES, INC., Pasadena, CA (US)

(72) Inventors: Anatoliy A. SAVCHENKOV, Glendale, CA (US); Andrey B. MATSKO, Pasadena, CA (US)

(21) Appl. No.: 16/284,228

(22) Filed: Feb. 25, 2019

Related U.S. Application Data
(60) Provisional application No. 62/636,023, filed on Feb. 27, 2018.

(51) Int. Cl. G01S 13/90; G01S 7/35

(52) U.S. Cl. CPC G01S 13/9023; G01S 7/352; G01S 7/35; G01S 13/9011

(57) ABSTRACT

The disclosure relates in sonic aspects to a radar device utilizing frequency modulated continuous waves (FMCW) to illuminate a target. The device uses two or more fixed transmitter antennas spaced apart to provide high resolution imaging with fast resolution time. In one example, the radar device includes: a signal source providing a transmission signal; a first transmitter for transmitting the signal as a first FMCW to a target; a second transmitter for transmitting the signal as a second FMCW to the target, where the first and second transmitters are spaced apart by a distance greater than a wavelength of the transmission signal; a receiver for receiving a reflected signal from the target; and an analyzer for determining the target distance and angle of the target with respect to the transmitters based on the received signal and the transmission signal. Radar devices with multiple input, multiple output transmitters are also described.

### PRIORITY CLAIM ANT) CROSS-REFERENCE TO RELATED APPLICATION

This patent document claims the priority of U.S. Provisional Application No. 62/636,023, entitled “METHODS AND APPARATUSES FOR IMPLEMENTING RADAR HAVING A SYNTHETIC APERTURE BY USING TWO OR MORE TRANSMIT ANTENNAS TRANSMITTING FREQUENCY MODULATED CONTINUOUS WAVE SIGNALS,” filed on Feb. 27, 2018, the entire disclosure of which is incorporated by reference herein.

### FIELD OF THE DISCLOSURE

Aspects of the disclosure relate to radar and, more particularly, to a radar that utilizes a multi-transmit antenna frequency modulated continuous wave architecture,

### BACKGROUND

Synthetic-aperture radar (SAR) is a form of radar that is used to create two or three-dimensional images of objects. Some SAR devices use the motion of a radar antenna over a target region to provide its spatial resolution. SAR is typically mounted on a moving platform such as an aircraft or spacecraft. Successive pulses of radio waves are transmitted to “illuminate” a target scene, and the echo of each pulse is received and recorded. As the SAR device on board the aircraft or spacecraft moves, the antenna location relative to the target changes with time, Signal processing of the successive recorded radar echoes received from the target allows for the combining of the recordings from the multiple antenna positions to create a SAR image. Thus, the distance the SAR system travels over a target in the time taken for the radar pulses to return to the antenna creates the synthetic antenna aperture, which may have an effective aperture size orders of magnitude larger than. the actual physical antenna used, The larger the aperture, the higher the image resolution, which allows SAR to create relatively high-resolution images with comparatively small physical antennas.

However, many SAR devices have distinct drawbacks, For example, a SAR device typically must be in constant motion (e.g., mounted to aircraft or spacecraft) in order to create its synthetic aperture. Moreover, the time needed to generate a high resolution SAR image is often directly tied to how fast the SAR device traverses through the target area while mounted onto its carrier (e.g., aircraft or spacecraft).

Phased array radar devices use a computer-controlled array of antennas to create a beam of radio waves that can be electronically steered to point in different directions without moving the antennas. In such systems, the radio frequency (RF) current from the transmitter is fed to the individual antennas with the correct phase relationship so that the radio waves from the separate antennas add together to increase the radiation in a desired direction, while cancelling to suppress radiation in undesired directions. In a phased array, the power from the transmitter is fed to the antennas through phase shifters that are controlled by a computer system, which can alter the phase electronically, thus steering the beam of radio waves to a different direction.

However, phased array radar devices can also have significant disadvantages. First, such devices may be prohibitively expensive for certain applications due to the large number (e.g., tens, hundreds, even thousands) of costly antennas that may be needed. Second, each antenna of a phased array may require a phase shifter, which further compounds problems associated with cost, size, and complexity. Third, targets within range of the phased array radar typically cannot be detected until the narrow beam formed by antennas cycles through and reaches the target during a sweep. Fourth, the antenna components in the phase array radar should be located at subwavelength distance one from the other, which is hard to achieve in high-frequency devices.

There is a need for radar devices that provide high quality images and fast image acquisition with reduced cost and design complexity. Such devices would ideally require less costly components and eliminate the need for moving components.

### SUMMARY

This document provides, among other features, methods and apparatus that implement an interferometric radar by using multiple antennas to transmit frequency modulated continuous wave signals, The described radar is not a synthetic aperture radar as it does not require any motion of the transmitter and/or receiver modules. The described device also is not a phased array antenna based radar as the antennas of the device can be located at an arbitrary distance each from the other.

In one aspect, a radar device includes: a signal source configured to provide a transmission signal; a first transmitter configured to transmit the transmission signal as a first frequency modulated continuous wave to a target; a second transmitter configured. to transmit the transmission signal as a second frequency modulated continuous wave to the target, the first and second transmitters spaced apart by a distance greater than a wavelength of the transmission signal; a receiver configured to receive a reflected signal from the target, wherein the reflected signal is a reflection of the transmission signal from the target; and an analyzer configured to determine a target distance and/or an angle of the target with respect to the first and/or second transmitter based on the received reflected signal and the transmission signal provided by the signal source.

In another aspect, a method includes: providing a frequency modulated continuous wave transmission signal to first and second transmitters that are spaced apart a distance greater than a wavelength of the transmission signal; transmitting the transmission signal from the first and second transmitters to a target; receiving a reflected signal from the target at a receiver, the reflected signal a reflection of the transmission signal from the target; and determining a target distance and/or an angle of the target with respect to the first and/or second transmitters based on the received reflected signal and the transmission signal.

In yet another aspect, an apparatus includes: means for generating a frequency modulated continuous wave transmission signal; means for transmitting the frequency modulated continuous wave transmission signal to a target using first and second transmitters that are spaced apart a distance greater than a wavelength of the transmission signal; means for receiving a reflected signal from the target at a receiver, the reflected signal a reflection of the transmission signal from the target; and means for determining a target distance and/or an angle of the target with respect to the first and/or second transmitters based on the received reflected signal and the transmission signal

### BRIEF DESCRIPTION OF TUE DRAWINGS

FIG. 1 illustrates an example of a radar device configured to utilize frequency modulated continuous waves (FMCW) to illuminate a target.

FIG. 2 illustrates an exemplary transmission signal.

FIG. 3 illustrates an exemplary transmission signal as transmitted by the transmitters of a radar device.

FIG. 4 illustrates an exemplary correlogram associated with a signal difference between reflected versions a pair of transmitted signals.

FIG. 5 illustrates an example of a radar device for use with multiple targets.

FIG. 6 illustrates an exemplary correlogram associated with signal differences between reflected signals from a pair of targets.

FIG. 7 illustrates an example with multiple targets having azimuth angles of 1, 5, 10, and 20 degrees with respect to a zero-angle azimuth plane.

FIG. 8 illustrates exemplary correlograms associated with the multiple targets of FIG. 7.

FIG. 9 illustrates an example with multiple targets having azimuth angles of 4, 30, 32, 34, and 40 degrees with respect to the zero-angle azimuth plane.

FIG. 10 illustrates exemplary correlograms associated with the multiple targets of FIG. 9.

FIG. 11 illustrates an example with a target at the same azimuthal angle as another target but further away from the transmitters.

FIG. 12 illustrates exemplary correlograms associated with two of the targets of FIG. 11.

FIG. 13 illustrates a schematic block diagram of a radar system that uses a photonic voltage controlled oscillator (VCO) and photonic links.

FIG. 14 illustrates a first exemplary multiple input, multiple output (MIMO) implementation of a radar device configured to utilize FMCW to illuminate a target.

FIG. 15 illustrates a second exemplary MIMO implementation of a radar device configured to utilize FMCW to illuminate a target.

FIG. 16 summarizes general features of an exemplary apparatus for illuminating a target.

FIG. 17 summarizes further features of an exemplary apparatus for illuminating a target.

FIG. 18 summarizes general features of an exemplary method that may be used to, for example, determine ranging information for a target.

FIG. 19 summarizes further features of an exemplary method that may be used to, fur example, determine ranging information for a target.

FIG. 20 summarizes an exemplary method that uses optical VCOs to generate a transmission signal.

FIG. 21 summarizes an exemplary method that uses a MIMO configuration to generate a 3D image of a target.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not he shown in detail in order not to obscure the aspects of the disclosure.

The word “exemplary” is used herein to mean “serving as an example, instance, or illustration.” Any implementation or aspect described herein as “exemplary” is not necessarily to be construed as preferred or advantageous over other aspects of the disclosure. Likewise, an aspect is an implementation or example. Reference in the specification to “an aspect,” “one aspect,” “some aspects,” “various aspects,” or “other aspects” means that a particular feature, structure, or characteristic described in connection with the aspects is included in at least some aspects, but not necessarily all aspects, of the present techniques. The various appearances of “an aspect,” “one aspect,” or “some aspects” are not necessarily all referring. to the same aspects. Elements or aspects from an aspect can be combined with elements or aspects of another aspect.

In the following description and claims, the term “coupled” may mean that two or more elements are in direct physical or electrical contact. However, “coupled” may also mean that two or more elements are not in direct contact with each other, but yet still co-operate or interact with each other.

Not all components, features, structures, characteristics, etc. described and illustrated herein need be included in a particular aspect or aspects. if the specification states a component, feature, structure, or characteristic “May,” “might,” “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element. it is to be noted that, although some aspects have been described in reference to particular implementations, other implementations are possible according to some aspects. Additionally, the arrangement and/or order of circuit elements or other features illustrated in the drawings and/or described herein need not be arranged in the particular way illustrated and described. Many other arrangements are possible according to sonic aspects.

In each figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

### Exemplary Embodiments

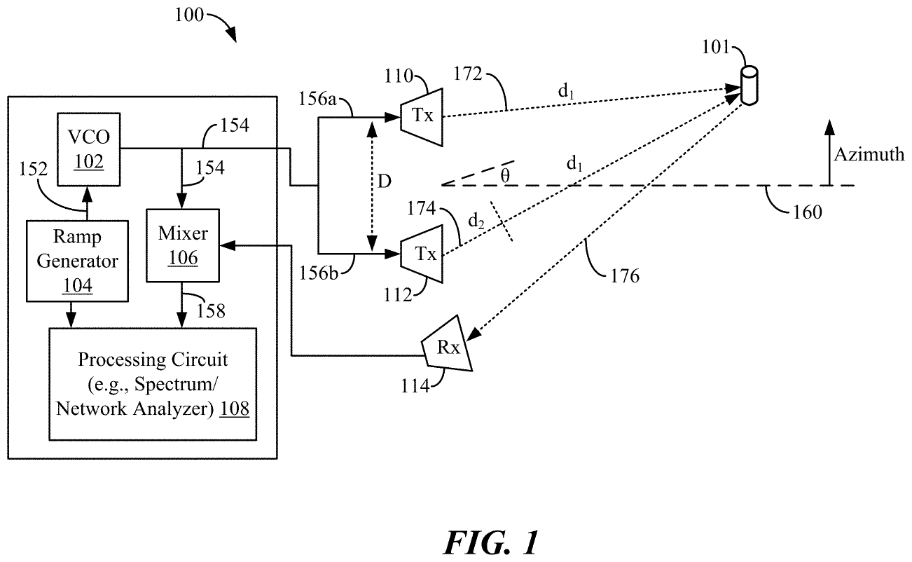

FIG. 1 illustrates a radar system or radar device 100 illuminating a target 101 according to one aspect of the disclosure. The radar device 100 utilizes frequency modulated continuous waves (FMCW) to illuminate the target 101. Unlike many SAR devices, the radar device 100 shown need not to be in motion, and unlike many phased array radars, radar device 100 does not need a large number of antennas or any phase shifters. Instead, the radar device 100 takes advantage of two or more transmitter (Tx) antennas spaced apart by a fixed, known distance D to provide high resolution imaging quickly (i.e., fast resolution time). The distance D may also be referred to as a spacing distance or spacing length.

The radar device 100 may include a voltage controlled oscillator (VCO) 102, a ramp generator 104, a mixer 106, a processing circuit 108 (e.g., spectrum analyzer, network analyzer, processor, etc.), a first transmitter 110, a second transmitter 112, and a receiver 114, The first and second transmitter 110, 112 antennas are separated from one another a known and fixed distance D, which is significantly longer than the wavelength of electromagnetic radiation transmitted by the transmitters 110, 112. The radar device 100 generally operates using an FMCW scheme where the ramp generator 104 provides one or more ramping voltage signals 152 to the VCO 102, which the VCO 102 uses to generate a frequency modulated transmission signal 154 that is fed to the first transmitter 110 via a first path 156a and the second transmitter 112 via a second path 156b. In one aspect of the disclosure, the path length of the first and second paths 156a, 156b is equal. The ramp generator 104 is also coupled to the processing circuit.

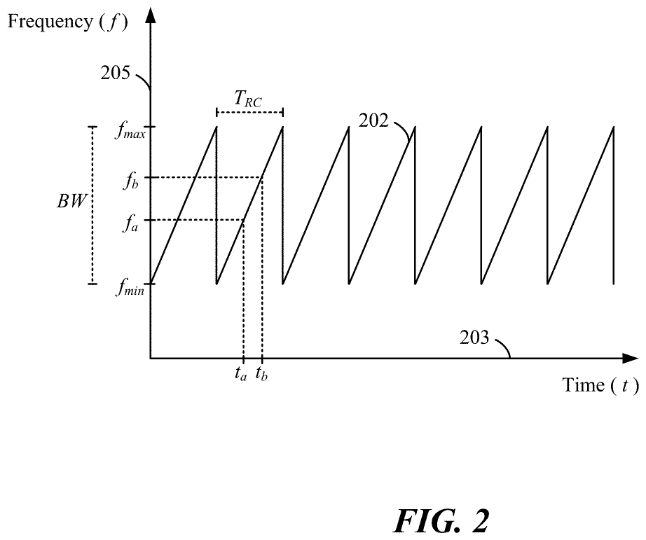

FIG. 2 illustrates an exemplary transmission signal 202 that may be supplied to the transmitters 110, 112 by the VCO 102 (i.e., signal 154 in FIG. 1). The transmission signal's 202 frequency may ramp up as shown, repeating periodically every T_{RC} seconds and having a frequency range of bandwidth (BW). Thus, the frequency of the transmission signal 202 at time tₐ may be fₐ and then later at time tᵢ, the frequency f_{b} of the transmission signal may be greater. In the figure, time (t) is shown on a horizontal axis 203 and frequency (f) is shown on a vertical axis 205. Specific numerical values for time (t) and frequency (f) are not shown as the graph is mostly intended to illustrate the shape of the ramp,

Referring to both FIGS. 1 and 2, the transmitters 110, 112 continuously transmit the transmission signal 202 out toward a general area of interest. A target 101 within range of the radar device 100 reflects the transmission signal so that a portion of the reflected signal 176 reaches the radar device's receiver antenna 114. The receiver antenna 114 then supplies the reflected signal 176 to a mixer 106 that mixes the reflected signal 176 with a portion of the transmission signal 154. The output signal 158 of the mixer 106 includes information about the target distance and angle of the target 101, and is supplied to a processing circuit 108 to extract such information. The output signal 158 may first run (or pass) through a low pass filter (not shown) before reaching the processing circuit 108, The distance d of the target 101 can be deduced or otherwise determined or detected based on the frequency difference between the target's reflected wave and the transmission signal broadcast at the point in time the reflected wave was received. The target's 101 angle can be determined as explained in greater detail below. Note that herein the distance to the target (or target distance) is denoted d, whereas the distance between the transmitters is denoted D. The target distance may also be referred to as the range L.

Since the path lengths 154, 156a, 156b from the VCO 102 to the first and second transmitters 110, 112 are substantially equal, the instantaneous frequency of the signals transmitted out from the transmit antennas 110, 112 at any given point in time are also equal. Consequently, signals transmitted out from the first and second transmitters 110, 112 reach a target located along the zero-angle azimuth plane 160 at the same time since the zero-angle azimuth plane is equidistant to both the first and second transmitters 110, 112.

By contrast, if a target, such as the target 101 shown in FIG. 1, is at an angle θ with respect to the zero-angle azimuth plane 160, then the path length d₁ of a transmission signal 172 broadcast by the closer first transmitter 110 is less than the path length d₁+d₂ of a transmission signal 174 broadcast by the second transmitter 112, which is further away from the target 101. Consequently, the time it takes for the second transmission signal 174 to reach the target 101 is longer than the time it takes for the first transmission signal 172. As explained below, this results in the transmission signals 172, 174 having different frequencies when they arrive at the target 101.

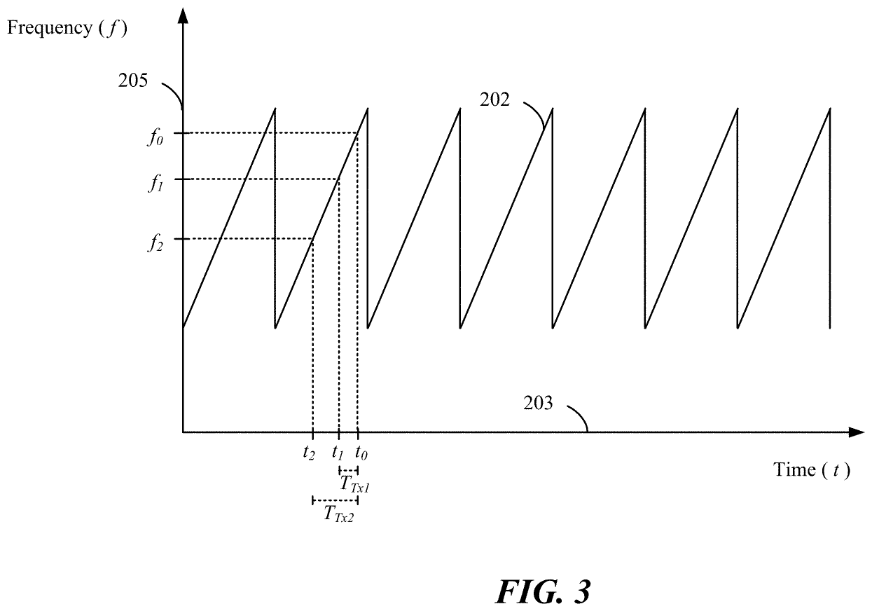

FIG. 3 illustrates the transmission signal 202 transmitted by the transmitters 110, 112. Time tₒ represents the instantaneous frequency of the transmission signal 202 currently being broadcast by the transmitters 110, 112. Time tⱼ represents the instantaneous frequency of the transmission signal 202 that was previously broadcast by the transmitters 110, 112 a time T_{TX1} ago, where T_{TX1} is the time it takes for the transmission signal 172 from the first transmitter 110 to reach the target 101. Time t₂ represents the instantaneous frequency of the transmission signal 202 that was previously broadcast by the transmitters 110, 112 a time T_{TX2} ago, where T_{TX2} is the time it takes for the transmission signal 174 from the second transmitter 112 to reach the target 101. Referring to FIGS. 1 and 3, it may be observed that the frequency f₂ of the second transmission signal 174 that reaches the target 101 is different (e.g., less) than the frequency f₁ of the first transmission signal 172 that reaches the target 101 since it takes longer for the second transmission signal 174 to reach the target 101.

This difference in frequency between the first and second transmission signals 172, 174 is directly proportional to the angle θ of the target 101. With a larger θ, the path length difference is greater between the first and second transmission signals 172, 174 to reach the target 101, and thus it takes a greater amount of time for one of transmission signals to cover the distance versus the other. That is, the greater the θ, the greater the time difference between the two transmission signals to the target 101.

The signal 176 reflected back from the target 101 is proportional to sin(2πfᵢt)+sin(2πf₂t). The distance D between the transmitters 110, 112 and the difference between f₂ and f₁ is analyzed by the processing circuit 108 to determine the angle θ. The difference between the frequency f₁ and fₚᵣₑₛₑₙₜ (currently transmitted signal's frequency) or the difference between the frequency f₂ and fₚᵣₑₛₑₙₜ may be used to determine the distance d between the target 101 and the transmitters 110, 112. The azimuth angular resolution is equal to c/(2*D*BW) and is thus unrelated to the carrier frequency of the transmitted signals. As with FIG. 2, time (t) is shown on a horizontal axis 203 and frequency (f) is shown on a vertical axis 205. Specific numerical values for are not shown as the graph is merely intended to illustrate the shape of the ramp.

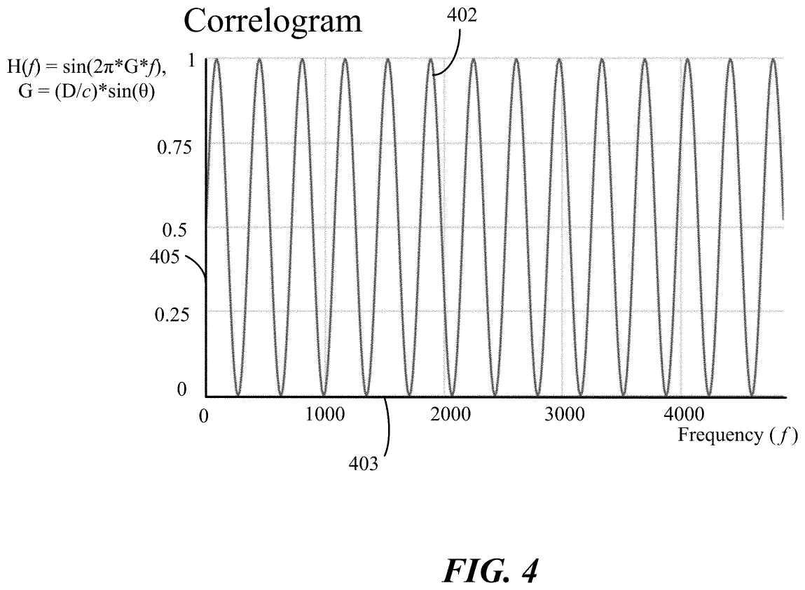

FIG. 4 illustrates a correlogram II(f) 402 associated with the beat signal (i.e., signal difference between the first and second transmitted signals 172, 174) received at the receiver 114 versus frequency f of the transmitted signal 202. (A correlogram may be described as an image representation of correlation statistics.) Specifically, H(f) 0.5+sin(2πGf), where G=(D/c)*sin(θ) and c is the speed of light in the medium the signals 172, 174, 176 travel through. A Fast Fourier Transform (FFT) of the correlogram H(f) provides the angle θ and the target distribution. In FIG, 4, H(f) is shown on a horizontal axis 203 and frequency (f) is shown on a vertical axis 205. Exemplary values are provided.

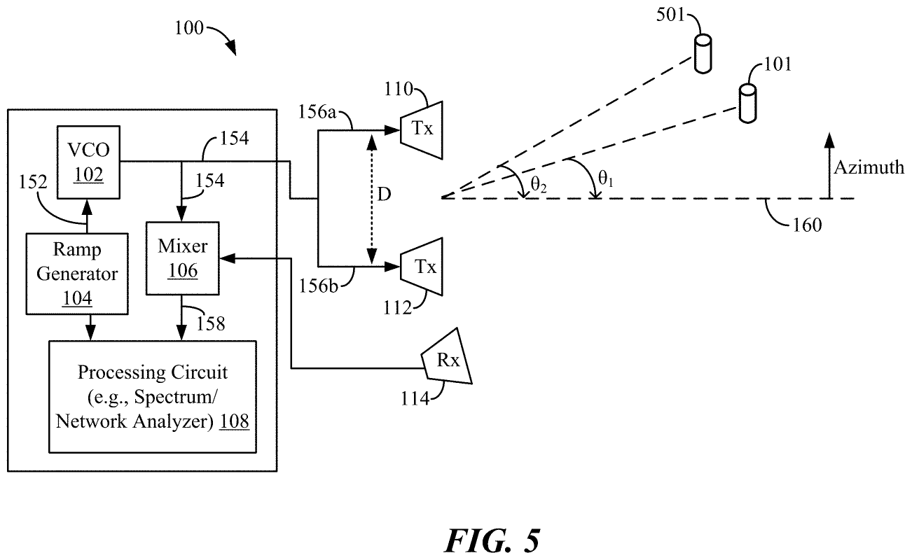

FIG. 5 illustrates a case where there are two targets 101, 501 within range of the radar device 100 at different azimuth angles θ₁ and θ₂. Each target 101, 501 thus provides a reflected signal having a different beat signal.

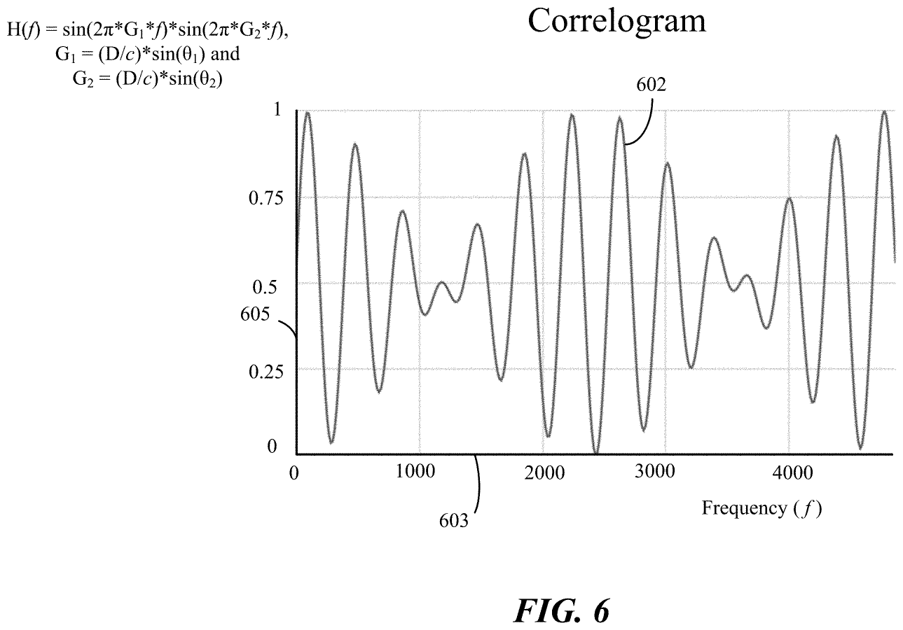

FIG. 6 illustrates a correlogram H(f) 602 associated with the beat signals of the first and second targets 101, 501. Here, H(f)−0.5+0.25*[sin(2πG₁f)+sin(2πG₂f)], where G₁=(D/c)*sin(θ₁) and G₂=(D/c)*sin(θ₂). An FFT of the correlogram F(f) provides the angle θ₁ and θ₂ the target distribution, The envelope of the H(f) 602 represents the signal associated with the target 101 that is closer to the zero-angle azimuth plane 160. In this example, H(f)=sin(2π*G₁*F)*sin(2πG₂*f), with G₁=(D/c)*sin(θ₁) and G₂=(D/c)*sin(θ₂). In FIG. 6, H(f) is shown on a horizontal axis 603 and frequency (f) is shown on a vertical axis 605. Exemplary values are provided.

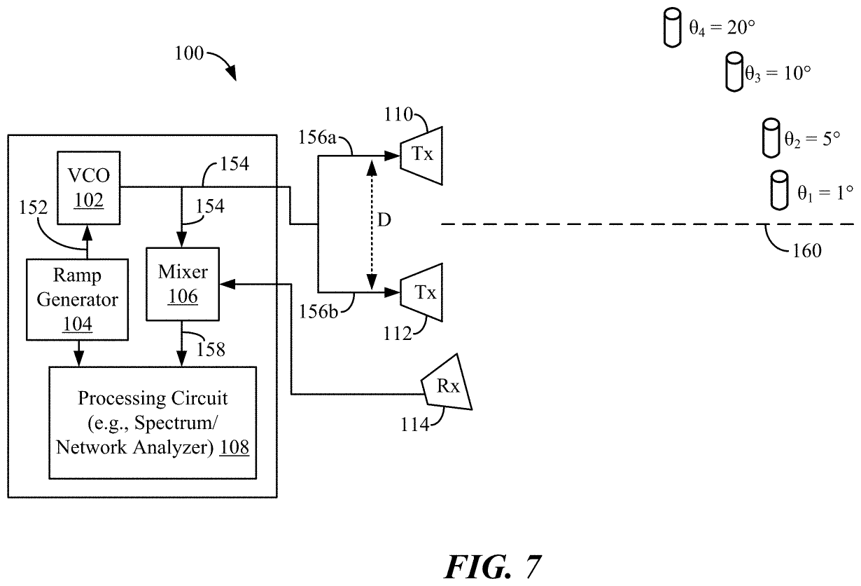

FIG. 7 illustrates an example with multiple targets having azimuth angles of 1, 5, 10, and 20 degrees with respect to the zero-angle azimuth plane.

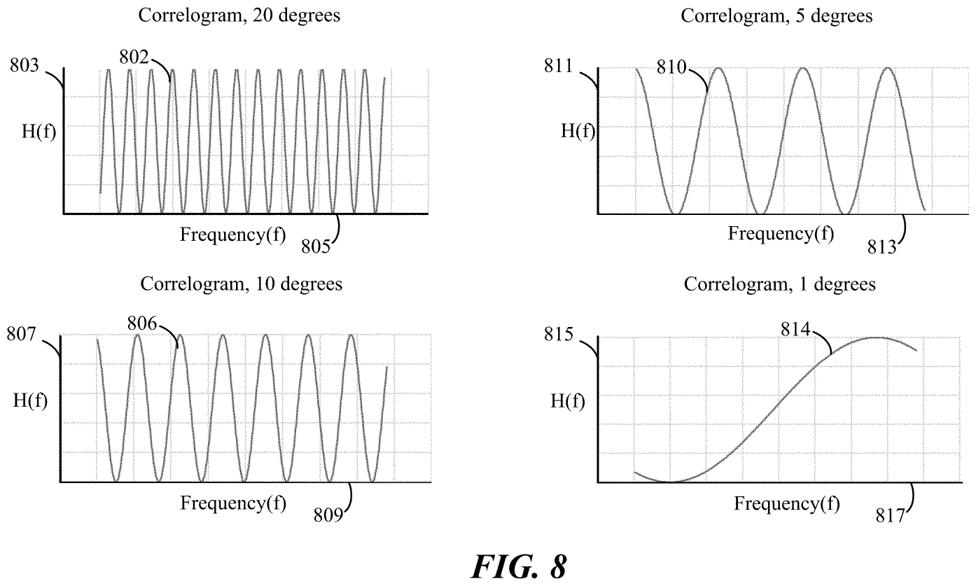

FIG. 8 illustrates correlograms H(f) for the multiple targets of FIG. 7. A first correlogram 802 is associated with the beat signals of the target at 20 degrees. H(f) is shown on a vertical axis 803 and frequency (f) is shown on a horizontal axis 805. A second correlogram 806 is associated with the beat signals of the target at 10 degrees with H(f) shown on a vertical axis 807 and frequency (f) shown on a horizontal axis 809. A third correlogram 810 is associated with the beat signals of the target at 5 degrees with H(f) shown on a vertical axis 811 and frequency (f) shown on a horizontal axis 813. A fourth correlogram 814 is associated with the beat signals of the target at 1 degrees with H(f) shown on a vertical axis 815 and frequency (f) shown on a horizontal axis 817. As may be observed, the larger the azimuth angle, the higher the oscillation frequency of the correlogram signal. Although not shown in these particular figures, the vertical axis is again scaled from 0.0 to 1.0.

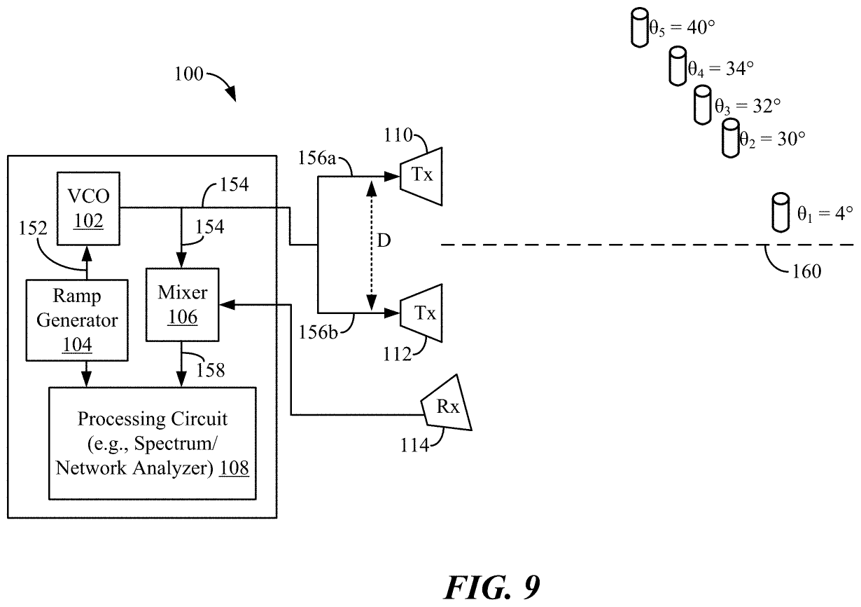

FIG. 9 illustrates an example with multiple targets having azimuth angles of 4, 30, 32, 34, and 40 degrees with respect to the zero-angle azimuth plane.

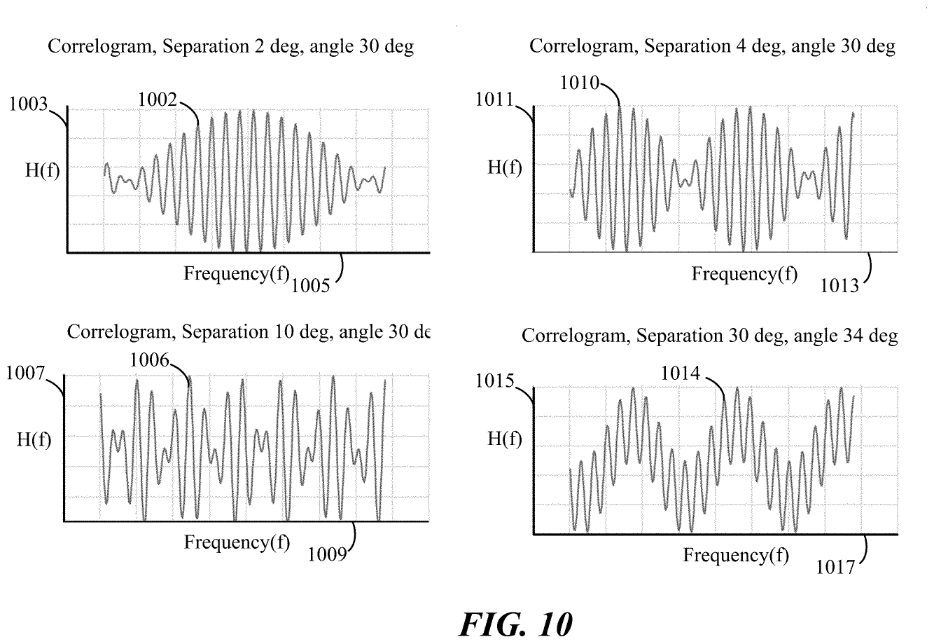

FIG. 10 illustrates correlograms H(f) for the multiple targets of FIG. 9. A first correlogram 1002 is associated with the beat signals of the target at 30 degrees with a separation of 2 degrees. H(f) is shown on a vertical axis 1003 and frequency (f) is shown on a horizontal axis 1005. A second correlogram 1006 is associated with the beat signals of the target at 30 degrees with a separation of 10 degrees. H(f) shown on a vertical axis 1007 and frequency (f) is shown on a horizontal axis 1009. A third correlogram 1010 is associated with the beat signals of the target at 30 degrees with a separation of 4 degrees. H(f) shown on a vertical axis 1011 and frequency (f) shown on a horizontal axis 1013. A fourth correlogram 1014 is associated with the beat signals of the target at 34 degrees with a separation of 30 degrees. H(f) shown on a vertical axis 1015 and frequency (f) shown on a horizontal axis 1017. As may be observed, the further apart the target pairs are from one another, the higher the oscillation frequency of the correlogram signal's envelope. Although not shown in these particular figures, the vertical axis is again scaled from 0.0 to 1.0.

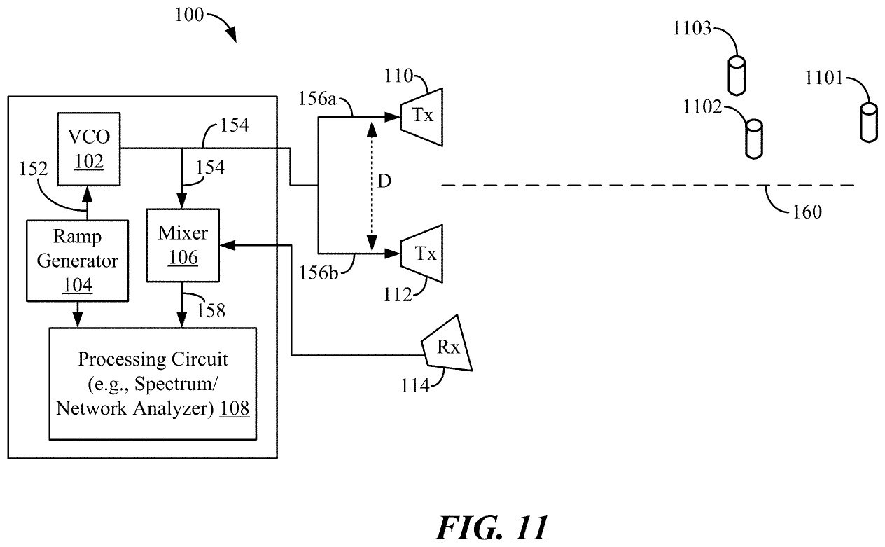

FIG. 11 illustrates three targets 1101, 1102, 1103. The first target 1101 is at the same azimuthal angle as the second target 1102 but is further away from the transmitters 110, 112.

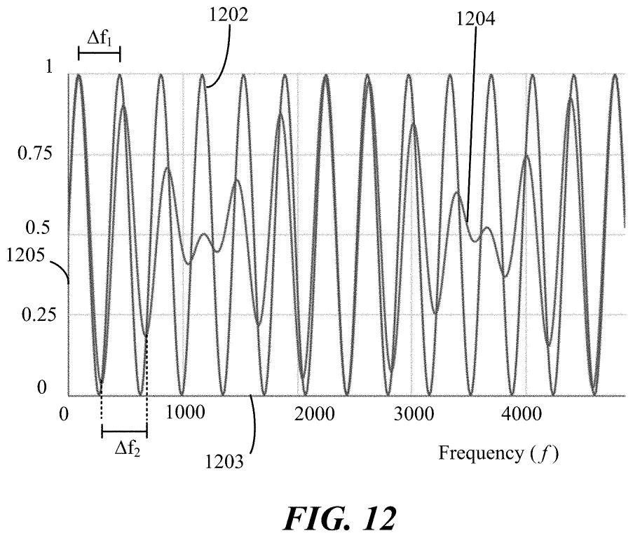

FIG. 12 illustrates a first correlogram 1202 of the first target 1101 individually and a second correlogram 1204 of the second and third targets 1102, 1103 taken as a pair. In FIG. 12, the relative values of the correlogram are shown on a horizontal axis 1203 and frequency (f) is shown on a vertical axis 205. Exemplary values are provided.

Referring FIGS. 11 and 12, in order to determine the range (i.e., distance) L₁ of the first target 1101 from the transmitters 110, 112, FMCW radar techniques are used to determine the difference in the first target's reflected signal 1176 with that of the transmission signal 154 being currently broadcast by the transmitters, Thus, the distance L₁=Δf₁*c/(2*(BW/T_{BC}), where Δf₁ is the frequency difference between the reflected signal 1176 and the currently transmitted signal 154. The range (i.e., distance) L₂ of the second target 1102 may be determined in the same fashion. The distance L₂=Δf₂* c/(2*(BW/T_{BC}), where Δf₂ is the frequency difference between the reflected signal 1178 and the currently transmitted signal 154. In some aspects, a frequency shifter may be positioned before the processing circuit 108 to shift the received signal's frequency by Δf₁ in order to generate the first correlogram 1202. Similarly, the frequency shifter may shift the received signal's frequency by Δf₂ to generate the second correlogram 1204.

### Photonic Implementation

In the examples described above, it was assumed that the path lengths 156a, 156b that lead from the VCO 102 to the transmitters 110, 112 are equal or that any differences are known so as to compensate for frequency output differences at the transmitters 110, 112. In one aspect, the VCO 102 may output an RE signal directly to the transmitters 110, 112. However, in such an implementation, the paths 156a, 156b, may introduce too much loss into the transmission signal 202 unless high quality, and expensive components are used. Thus, transmitting an RE signal from the VCO 102 to the transmitters 110, 112 may be possible but may be impractical.

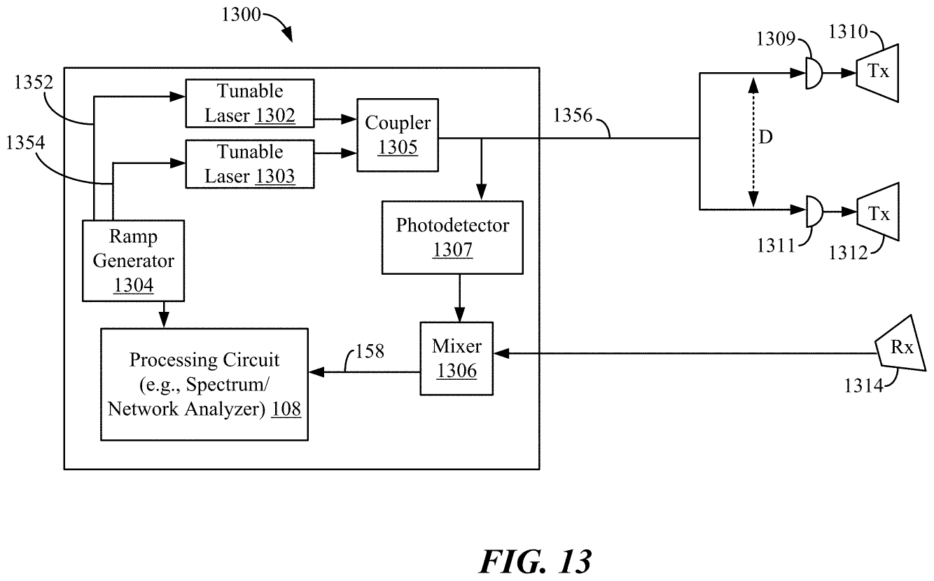

FIG. 13 illustrates a schematic block diagram of a radar system 1300 similar to that shown in FIG. 1, but which uses a photonic VCO and photonic links according. The radar device 1300 may include a pair of tunable lasers (e.g., optical VCOs) 1302, 1303, a ramp generator 1304, an optical coupler 1305, a mixer 1306, photodetectors 1307, 1309, 1311, a processing circuit 1308 (e.g., spectrum analyzer, network analyzer, processor, etc.), a first transmitter 1310, a second transmitter 1312, and a receiver 1314. In the example shown in FIG. 13, the ramp generator 1304 may output a first ramping signal 1352 (e.g., a ramp-up signal) that is fed to the first tunable laser 1302 and a second ramping signal 1354 (e.g., a ramp-down signal) that is fed to the second tunable laser 1303. The ramping signals 1352, 1354 modulate the frequency output of the tunable lasers 1302, 1303. The optical outputs of the tunable lasers 1302, 1303 have varying modulated frequencies f₁ and f₂ and are coupled together via the optical coupler 1305. The combined optical signal is then transmitted to each transmitter subassembly 1320, 1322 over an optical link 1356 such as, but not limited fiber optical cable. Notably, the optical link 1356 has negligible loss and thus the modulated light carrier wave may be distributed to the transmitter subassemblies cost effectively without concern for signal degradation. Photodetectors 1309, 1311 at each subassembly 1320, 1322 convert the modulated light carrier wave into an. RF signal having a frequency represented by the difference between the first and second tunable laser outputs.

A portion of the modulated light carrier wave is input to another photodetector 1307 that supplies the RF signal to the mixer 1306. The mixer 1306 also receives the reflected RF signal from one or more targets to generate the beat signal for processing by the processing circuit 1308 as described above with respect to FIGS. 1-12.

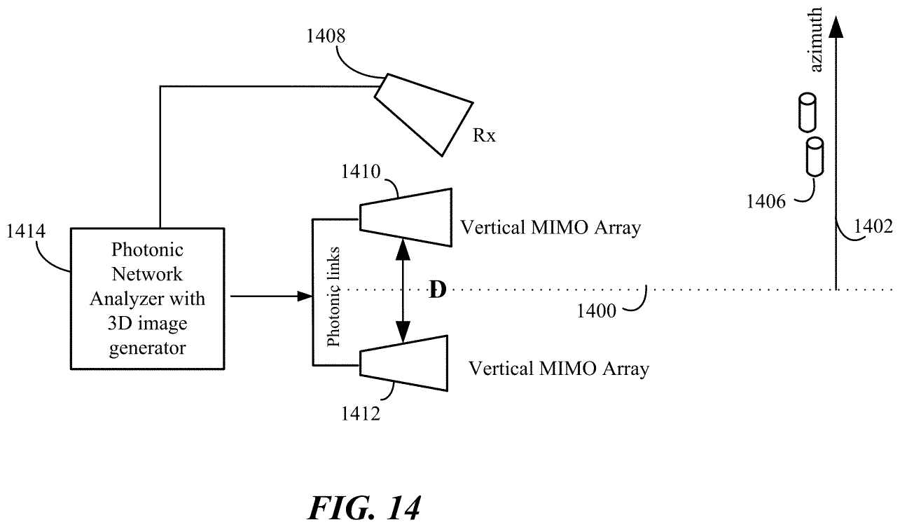

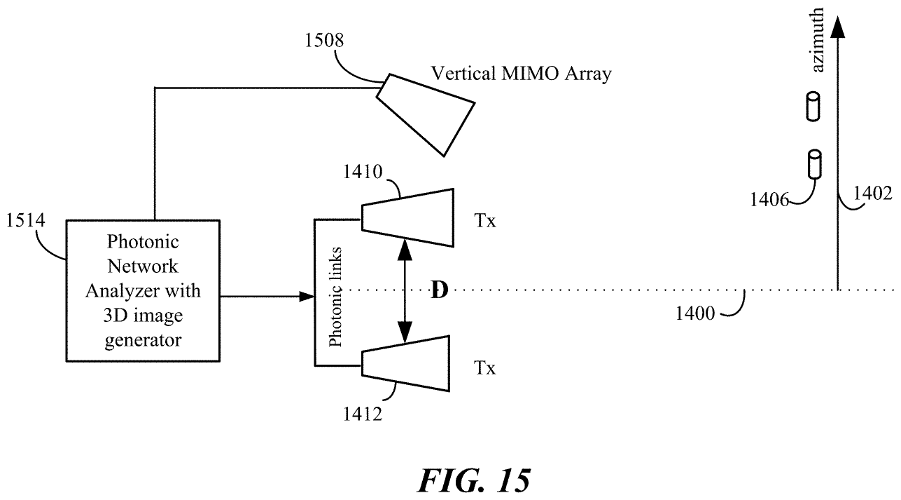

FIGS. 14 and 15 illustrate alternative embodiments of the radar system, which incorporate multiple-in-multiple-out antenna arrays that may be used for three-dimensional (3D) imaging. As shown in FIG. 14, to perform 3D detection, a first multiple input, multiple output (MIMO) matrix (or vertical MIMO array) 1410 and a second vertical MIMO matrix or array 1412 may be arranged to transmit generally along an axis 1400 that is orthogonal to an azimuth axis 1402. That is, the two vertical MIMO arrays 1410 and 1412 are placed orthogonally to the main transmission axis 1400. Each vertical MIMO array may be, for example, an AWR1243 provided by Texas Instruments. The AWR1243 is an integrated single-chip FMCW transceiver that operates in the 76- to 81-GHz band. The two vertical MIMO arrays are spaced at least a distance D (where D is again significantly longer than the wavelength of the FMCW signals) apart and are coupled to a photonic network analyzer 1414 with a 3D image generator. The network analyzer may include one or more VCOs to reduce clutter. A separate receiver 1416 is provided as well. The configuration of FIG. 15 allows for angular target recognition along the vertical (azimuthal) axis 1402.

In one example, each vertical MIMO array 1410 and 1412 includes N transmitters arranged vertically (i.e. orthogonal to transmission axis 1400 and parallel with azimuth axis 1402). Hence, 2*N versions of the FMCW transmission signals are sent to a target, such as exemplary target 1406, and 2*N versions of the reflected signal are received by a receiver 1408. The received signals are routed into a photonic network analyzer 1414, which determines the different target distances and angles to each of 2*N different points on the surface of the target 1406 that is facing the radar. From these signals, the network analyzer 1414 determines the shape (or profile) of one vertical slice of the surface of the target facing the transmitters. The shape of the slice may consist, for example, of 2*N points, each represented by a distinct distance and azimuth. As the target moves relative to the transmitters (or the transmitters move relative to the target, or both) along an axis that is orthogonal to both axis 1400 and axis 1402, additional vertical slices of the target are scanned. The network analyzer 1414 uses a set of slices obtained over a period of time (e.g. M slices obtained over T seconds) to generate a 3D image of the surface of the target facing the transmitters, with the number of points in the resulting 3D image equal to 2*N*M. In various examples, N may be in the range of 5-100 (e.g. 5, 10, 50, or 100), and M also may be in the range of 5-100 (e.g. 5, 10, 20, 50, or 100). These values are merely illustrative. The greater the number of transmitters N in each MIMO, the higher the resolution. T may be, e.g., in the range of 0.1 seconds to 1 second. If the target is rotating relative to the transmitters, or the transmitters move around the target, then similar 3D images may be generated for other surface portions of the target, such as its rear surface or its top or bottom surfaces so as to provide a more complete 3D image of the entire surface of the target.

As shown in FIG. 15, a single vertical MIMO array 1508 may be positioned along the vertical axis relative to two non-MIMO transmitters 1510 and 1512 of the type discussed above. In this arrangement, a separate receiver is not provided as the MIMO 1508 operates as a transceiver to both receive and transmit signals. A photonic network analyzer 1514 is coupled the transmitters 1510 and 1512 and to the vertical MIMO array 1508. The radar system of FIG. 15 may operate generally as described above to generate a 3D image of the surface of the target 1406 based on a set of vertical image slices.

Some advantages of at least sonic implementations of the radar methods and devices described herein include:

High aperture: In one aspect, the radar is practical because by using a low phase noise, broadband, tunable photonic VCO, the high frequency optical signal of photonic VCO can be transmitted with very low loss and very low crosstalk between Tx elements over large distance via photonic link such as an optical fiber.

High resolution: The photonic VCO creates a broadly tunable RF signal by demodulating two or more optical tones on a fast photodiode photodetector). The resolution of the configuration presented is proportional to the bandwidth of VCO. Broad bandwidth of the VCO allows for high resolution. For instance an 80 GHz VCO bandwidth leads to 0.2 deg resolution if placed on a front face of an apparatus. The VCO tuning range can exceed an octave.

To achieve high spectral purity of the optical tones lasers may be locked to high quality factor tunable optical resonators. The tunability of VCO frequency is achieved because of the relative tunability of the optical tones. The tuning of the optical tones can be achieved electro-optically, or mechanically, or by temperature variations, applied to the high-Q factor optical resonators used to increase the spectral purity of the optical tones.

An example of a VCO that may be used in radar devices described herein is a VCO represented by two lasers locked to two high-Q independently tunable resonators (e.g., see FIG. 13). The beat signal of the lasers represents the tunable RF signal. To control the signal waveform the lasers could-be offset-locked.

Another example of a VCO that may be used in radar devices described herein is a VCO represented by locking two lasers to two different modes of the same tunable optical resonator. The relative frequency of the lasers can be tuned by tuning the frequency difference between the resonator modes.

An example of a VCO that may be used in radar devices described herein is a VCO represented by a tunable opto-electronic oscillator. The broad frequency tuning enabled by the photonic VCO is important for large range and angular resolution. The broad frequency tuning of the VCO makes the system stable with respect to clutter.

In some aspects of the disclosure are described frequency-manipulation/sweep SAR systems that consists of two or more spatially separated ordinary or MIMO transmission antennas forming a sequence of complex beams in the far field. The Rx antenna receives the reflected signals from the targets and a mathematically processed record of the signal forms the far field.

In some aspects, the radar devices described herein may exploit the advantage of photonic links between Tx transmitters. Doing so may eliminate problems associated with high (if not forbidding) transmission line loss across long signal paths in the mm-band. The systems described herein may have a photonic source of FMCW swept signal that is transmitted to Tx subassemblies practically loss-free and is converted to RF or mm radiation at Tx subassemblies.

In some aspects, the radar devices described herein may exploit a wide bandwidth photonic VCO that provides an improved angular resolution where the angular resolution is c/(2*D*VCO_bandwidth). In some aspects, the radar devices described herein exploit a narrowband and fast-sweeping rate photonic VCO that provides an improved radial resolution since radial resolution is proportional the linewidth of VCO and inversely proportional to a sweep rate of VCO. In sonic aspects, the radar devices described herein do not have to have any moving parts or active phase shifters, All beam manipulations may happen or occur in the frequency domain.

### Summary of General Features and Embodiments

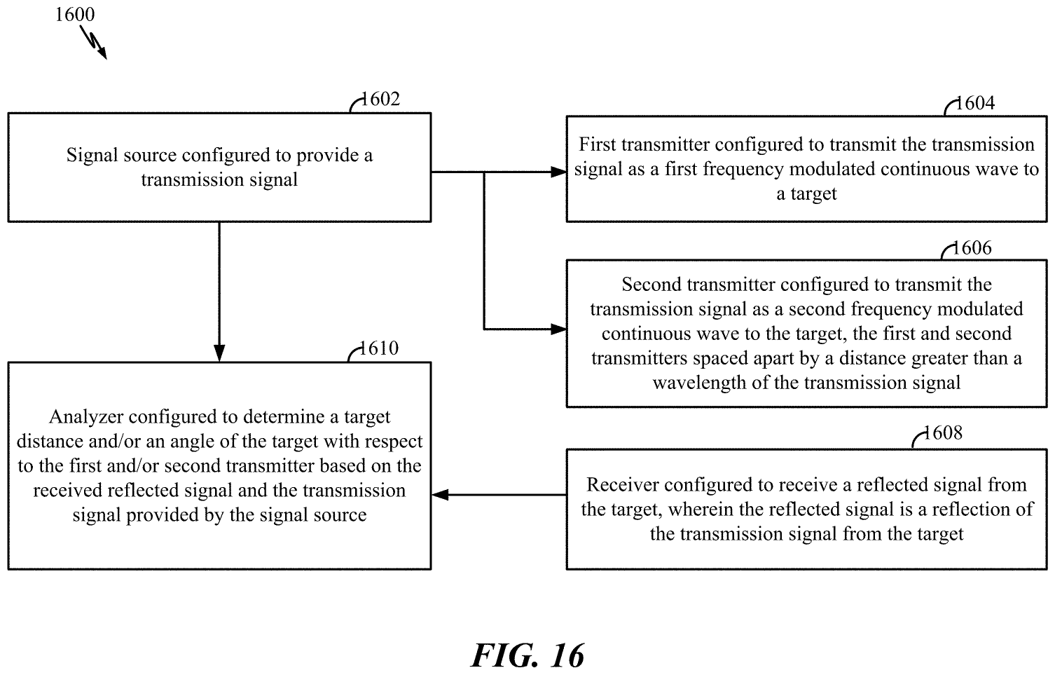

FIG. 16 summarizes general features of an exemplary apparatus 1600. Briefly, a signal source 1602 is configured to provide a transmission signal, such as an RF signal, though, in other examples, it might be an optical signal. A first transmitter 1604 is configured to transmit the transmission signal as a first frequency modulated continuous wave to a target. As noted above, if the initial signal is an optical signal, the optical signal might be converted to an RF signal for transmission. A second transmitter 1606 is configured to transmit the transmission signal as a second frequency modulated continuous wave to the target, where the first and second transmitters spaced are apart by a distance greater than a wavelength of the transmission signal and, preferably, significantly greater. A receiver 1608 is configured to receive a reflected signal from the target, wherein the reflected signal is a reflection of the transmission signal from the target. An analyzer 1610 is configured to determine a target distance and/or an angle of the target with respect to the first and/or second transmitter based on the received reflected signal and the transmission signal provided by the signal source.

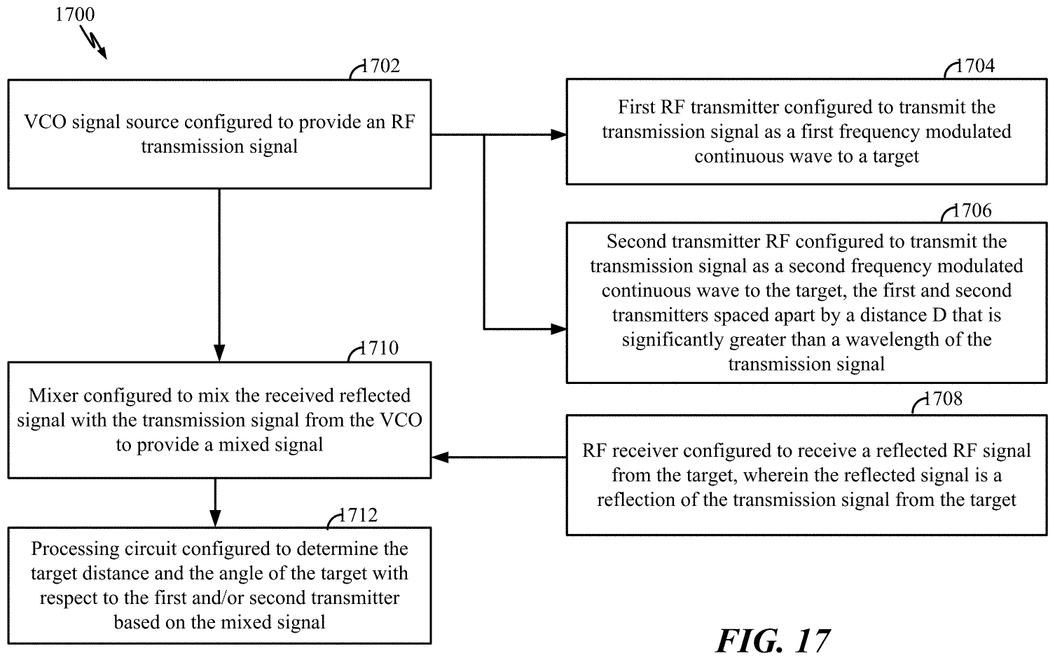

FIG. 17 summarizes further features of exemplary apparatus 1700. Briefly, a VCO signal source 1702 is configured to provide an RF transmission signal. A first transmitter 1704 is configured to transmit the RE transmission signal as a first frequency modulated continuous wave to a target. A second RF transmitter 1706 is configured to transmit the transmission signal as a second frequency modulated continuous wave to the target, where the first and second transmitters spaced are apart by a distance D that is significantly greater than a wavelength of the transmission signal. An RF receiver 1708 is configured to receive a reflected RF signal from the target, wherein the reflected signal is a reflection of the transmission signal from the target. A mixer 1710 is configured to mix the received reflected signal with the transmission signal from the VCO to provide a mixed signal. A processing circuit 1712 is configured to determine the target distance and the angle of the target with respect to the first and/or second. transmitter based on the mixed signal.

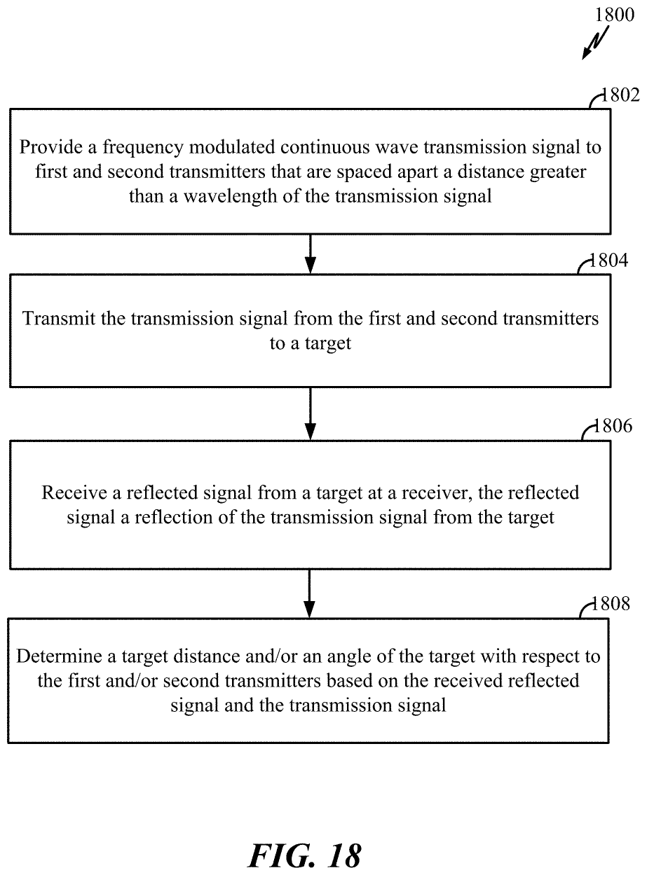

FIG. 18 summarizes general features of an exemplary method 1800 that may be used to, for example, determine ranging information for a target. Briefly, at block 1802, a suitably-equipped system, device or apparatus provides a frequency modulated continuous wave transmission signal to first and second transmitters that are spaced apart a distance greater than a wavelength of the transmission signal and, preferably, significantly greater. At block 1804, the apparatus transmits the transmission signal from the first and second transmitters to a target. At block 1806, the apparatus receives a reflected signal from the target at a receiver, the reflected signal being a reflection of the transmission signal from the target. At block 1808, the apparatus determines a target distance and/or an angle of the target with respect to the first and/or second transmitters based on the received reflected signal and the transmission signal.

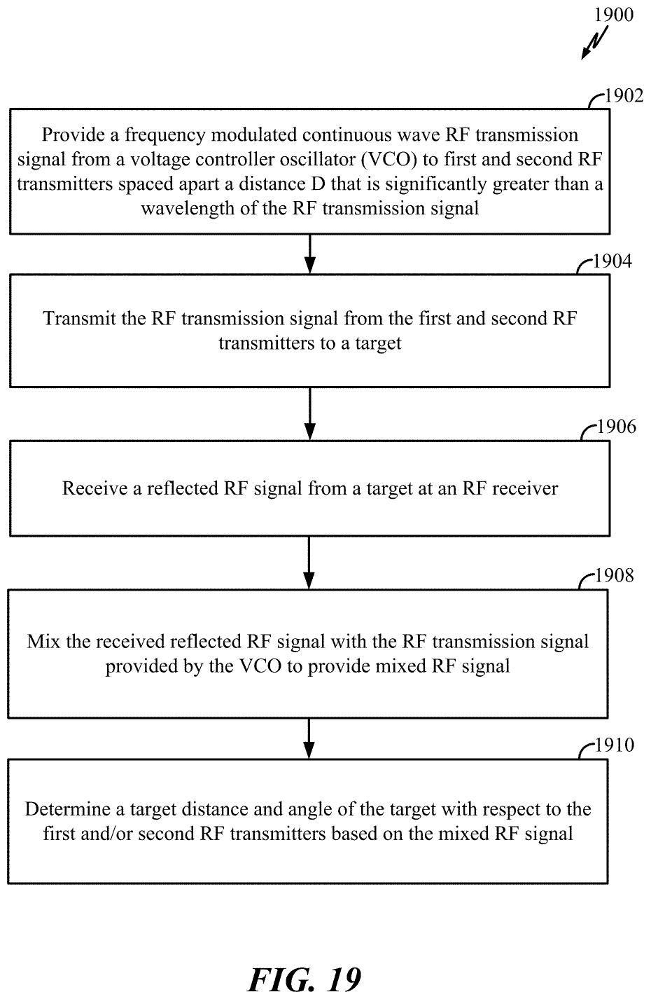

FIG. 19 summarizes further features of an exemplary method 1900 that may be used to, for example, determine ranging information. Briefly, at block 1902, a suitably-equipped system, apparatus or device uses a VCO to provide a frequency modulated continuous wave RF transmission signal to first and second RE transmitters that are spaced apart a distance D that is greater than a wavelength of the RF transmission signal and, preferably, significantly greater. At block 1904, the apparatus transmits the RF transmission signal from the target using the first and second RF transmitters. At block 1806, the apparatus receives a reflected RE signal from the target at an RF receiver, the reflected signal a reflection of the transmission signal from the target. At block 1808, the apparatus uses an RF mixer to mix the received reflected RF signal with the RF transmission signal provided by the VCO to provide mixed RF signal. At block 1910, the apparatus uses a processing circuit to determine the target distance and the angle of the target with respect to the first and/or second RF transmitters based on the mixed RF signal.

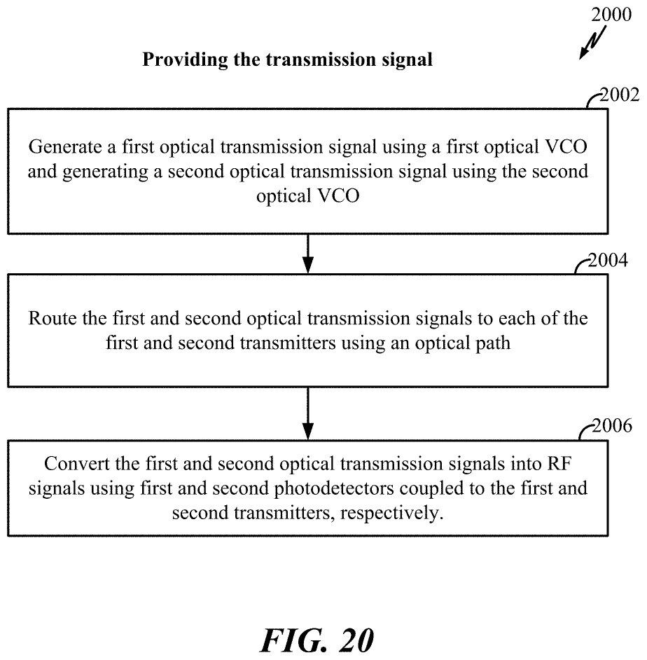

FIG. 20 summarizes an exemplary method 2000 that uses optical VCOs to generate the transmission signal. Briefly, at block 2002, a first optical transmission signal is generated using a first optical VCO and a second optical transmission signal is generated using the second optical VCO. At block 2004, the first and second optical transmission signals are routed to each of the first and second transmitters using an optical path. At block 2006, the first and second optical transmission signals are converted into RF signals using first and second photodetectors coupled to the first and second transmitters, respectively.

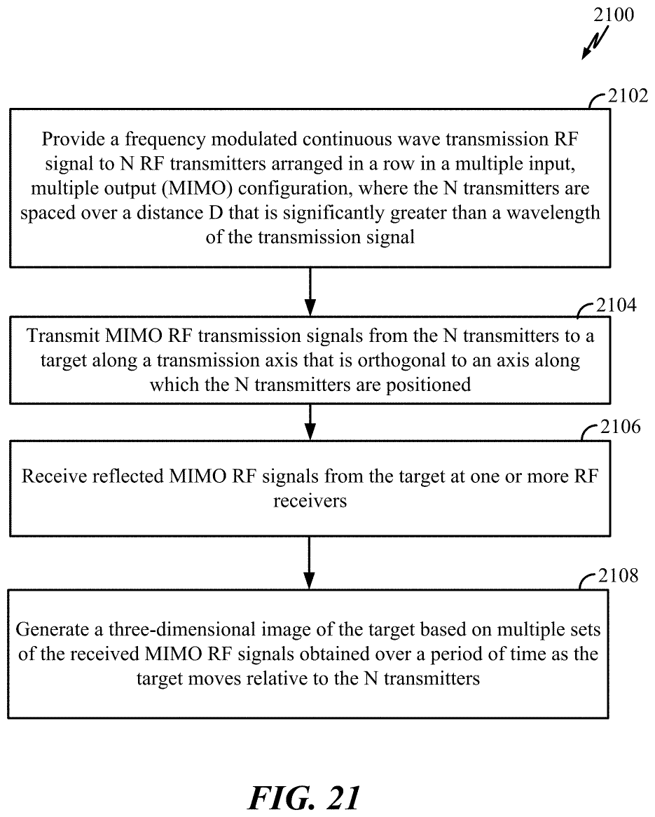

FIG. 21 summarizes an exemplary method 2100 that uses a MIMO configuration to generate 3D images of a target. Briefly, at block 2102, a frequency modulated continuous wave transmission signal is provided to N RF transmitters arranged in a row in a MIMO configuration, where the N transmitters are spaced over a distance D that is significantly greater than a wavelength of the transmission signal. At block 2104, the MIMO RF transmission signals are transmitted from the N transmitters to a target along a transmission axis that is orthogonal to an axis along which the N transmitters are positioned. At block 2106, reflected MIMO RF signals from the target are received at one or more RF receivers. In some examples, and as described above, the transmitters and the receivers are integrated as MIMO transceivers. At block 2108, a processor such as a photonic network analyzer generates a three-dimensional image of at least a surface portion of the target based on the received MIMO RF signals obtained over a period of time as the target moves relative to the N transmitters. N may be, for example, 10 or 100.

The various components and functions shown in FIGS. 1-21 may be replaced with a suitable means for performing or controlling corresponding operations. Hence, in at least some examples, an apparatus may include one or more of: means for generating a frequency modulated continuous wave transmission signal; means for providing the frequency modulated continuous wave transmission signal to first and second transmitters that are spaced apart a distance greater than a wavelength of the transmission signal; means for transmitting the transmission signal from the first and second locations to a target; means for receiving a reflected signal from the target, the reflected signal a reflection of the transmission signal from the target; means for determining a target distance and/or an angle of the target with respect to the first and/or second transmitters based on the received reflected signal and the transmission signal; means for mixing the received reflected signal with the transmission signal provided by the signal source to provide mixed signal; means for determining the target distance and the angle of the target with respect to first and/or second transmitters from the mixed signal; means for generating first and second optical transmission signals; means for routing the optical signals to each of the first and second transmitters; means for converting the first and second optical signals into first and second RE signals, respectively; means for providing a frequency modulated continuous wave transmission signal to N transmitters arranged in a row in a MIMO configuration, where the N transmitters are spaced over a distance D that is greater than a wavelength of the transmission signal; means for transmitting MIMO signals from the transmitters to a target; means for receiving reflected MIMO signals from the target; and means for generating a three-dimensional image of at least a portion of the target based on the received MIMO signals obtained over a period of time as the target moves relative to the N transmitters.

One or more of the components, steps, features, and/or functions illustrated in FIGS. 1, 2, 3, 4, 5, 6, 7, 8, 9, 10, 11, 12, 13, 14, 15, 16, 17, 18, 19, 20 and/or 21 may be rearranged and/or combined into a single component, step, feature or function or embodied in several components, steps, or functions. Additional elements, components, steps, and/or functions may also be added without departing from the invention. The algorithms described herein may also be efficiently implemented in software and/or embedded in hardware.

Also, it is noted that the aspects of the present disclosure may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Information generated by the methods and apparatus described herein may be stored in a storage medium. A storage medium may represent one or more devices for storing data, including read-only memory (ROM), random access memory (RAM), magnetic disk storage mediums, optical storage mediums, flash memory devices and/or other machine-readable mediums and, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing or containing instruction(s) and/or data. Thus, the various methods described herein may be fully or partially implemented by instructions and/or data that may be stored in a “machine-readable medium,” “computer-readable medium,” and/or “processor-readable medium” and executed by one or more processors, machines and/or devices.

Furthermore, aspects of the disclosure may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing aspects of the disclosure are merely examples and are not to be construed as limiting the invention. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. A radar device comprising:
a signal source configured to provide a transmission signal;
a first transmitter configured to transmit the transmission signal as a first frequency modulated continuous wave to a target;
a second transmitter configured to transmit the transmission signal as a second frequency modulated continuous wave to the target, the first and second transmitters spaced apart by a distance greater than a wavelength of the transmission signal;
a receiver configured to receive a reflected signal from the target, wherein the reflected signal is a reflection of the transmission signal from the target; and
an analyzer configured to determine a target distance and/or an angle of the target with respect to the first and/or second transmitter based on the received reflected signal and the transmission signal provided by the signal source.

2. The radar device of claim 1,
wherein the signal source comprises a voltage controlled oscillator (VCO), and
wherein the analyzer comprises
a mixer configured to mix the received reflected signal with the transmission signal from the VCO to provide a mixed signal; and
a processing circuit configured to determine the target distance and the angle of the target with respect to the first and/or second transmitter based on the received reflected signal and the mixed signal.

3. The radar device of claim 2, wherein the transmission signal provided by the VCO is a radio frequency (RF) signal.

4. The radar device of claim 2, further comprising a ramp generator coupled to the VCO and the processing circuit, the ramp generator providing voltage ramp signal for use by the VCO to generate the frequency modulated continuous wave signal.

5. The radar device of claim 2,
wherein the VCO includes a first optical VCO and a second optical VCO, the first optical VCO configured to generate a first optical transmission signal and the second optical VCO configured to generate a second optical transmission signal, and
wherein the radar device further comprises:
an optical link configured to route the first and second optical transmission signals to each of the first and second transmitters, the first and second transmitters each including a photodetector configured to convert the first and second optical transmission signals into an RF signal for transmission to the target.

6. The radar device of claim 5, wherein the first optical VCO comprises a first tunable laser and the second optical VCO comprises a second tunable laser.

7. The radar device of claim 1, wherein the first and second transmitters are each multiple input, multiple output (MIMO) transceivers.

8. The radar device of claim 7, wherein the MIMO transceivers are configured and positioned to provide three-dimensional (3D) image information of the target as the target moves relative to the radar device.

9. The radar device of claim 1, further comprising:
in addition to the first and second transmitters, a plurality of additional transmitters arranged in a multiple input, multiple output (MIMO) configuration.

10. The radar device of claim 1, wherein the processing circuit comprises a spectrum analyzer or a network analyzer.

11. A method, comprising:
providing a frequency modulated continuous wave transmission signal to first and second transmitters that are spaced apart a distance greater than a wavelength of the transmission signal;
transmitting the transmission signal from the first and second transmitters to a target;
receiving a reflected signal from the target at a receiver, the reflected signal a reflection of the transmission signal from the target; and
determining a target distance and/or an angle of the target with respect to the first and/or second transmitters based on the received reflected signal and the transmission signal.

12. The method of claim 11, wherein the transmission signal is provided by a voltage controlled oscillator (VCO), and wherein determining the target distance and/or the angle of the target comprises:
mixing the received reflected signal with the transmission signal provided by the VCO to provide mixed signal; and
determining the target distance and the angle of the target with respect to the first and/or second transmitter based on the mixed signal.

13. The method of claim 12, wherein the transmission signal provided by the VCO is a radio frequency (RF) signal.

14. The method of claim 12, wherein providing the transmission signal includes:
generating a first optical transmission signal using a first optical VCO and generating a second optical transmission signal using a second optical VCO;
combining the first and second optical transmission signals;
converting the combined optical transmission signal into RF signals using first and second photodetectors;
routing the RE signals to the first and second RF transmitters.

15. The method of claim 11, further comprising:
providing additional transmission signals to additional transmitters arranged in a multiple input, multiple output (MIMO) configuration; and
transmitting the additional transmission signals from the additional transmitters to the target.

16. The method of claim 15, further comprising generating three-dimensional (3D) imagery of at least a portion of the target based on received reflected MIMO signals from the target as the target moves relative to the radar device.

17. The method of claim 11, wherein the first and second transmitters are multiple input, multiple output (MIMO) transmitters and wherein the method further comprises:
generating three-dimensional (3D) imagery of the target based on the received reflected MIMO signals as the target moves relative to the radar device.

18. An apparatus, comprising:
means for generating a frequency modulated continuous wave transmission signal;
means for transmitting the frequency modulated continuous wave transmission signal to a target using first and second transmitters that are spaced apart a distance greater than a wavelength of the transmission signal;
means for receiving a reflected signal from the target at a receiver, the reflected signal a reflection of the transmission signal from the target; and
means for determining a target distance and/or an angle of the target with respect to the first and/or second transmitters based on the received reflected signal and the transmission signal.

19. The apparatus of claim 18, wherein the means for determining the target distance and/or the angle of the target comprises:
means for mixing the received reflected signal with the transmission signal provided by the means for generating to provide mixed signal; and
means for determining the target distance and the angle of the target based on the mixed signal.

20. The apparatus of claim 18, wherein the means for generating the transmission signal comprises:
means for generating a first optical transmission signal and a second optical transmission signal;
means for routing the first and second optical transmission signals to each of the first and second transmitters; and
means for converting the first and second optical transmission signals into RF signals for transmission.
